(19) United States
(12) Patent Application Publication
(10) Pub. No.: US 2024/0350843 A1
(43) Pub. Date: Oct. 24, 2024

(54) FIRE FIGHTING DRONE CONFIGURED TO BE RELEASED FROM AN AIRCRAFT

(71) Applicant: LEONARDO S.P.A., ROMA (IT)

(72) Inventors: Antonio Piccolo, TORINO (IT); Emanuele Bottone, TORINO (IT); Gaetana Mastroianni, TORINO (IT); Umberto Papa, TORINO (IT)

(73) Assignee: LEONARDO S.P.A., ROMA (IT)

(21) Appl. No.: 18/291,625

(22) PCT Filed: Mar. 20, 2023
(86) PCT No.: PCT/IB2023/052716

§ 371 Date: Jan. 24, 2024

(30) Foreign Application Priority Data
Jun. 28, 2022 (IT) 102022000013687

(51) Int. Cl. A62C 3/02; B64U 30/21; B64U 70/20; B64U 101/47

(52) U.S. Cl. CPC A62C 3/0235; B64U 30/21; B64U 70/20; B64U 2101/47

(57) ABSTRACT

Fire fighting drone comprising an exoskeleton defining an internal space extending along an axis H and a flexible bag stably housed in the internal space, provided with a release valve and configured to contain a fire fighting liquid; a support structure provided with a plurality of thrusters adapted to perform a thrust that enables the support structure to be supported in flight; the support structure is connected to a first end portion of the exoskeleton; a plurality of movable directional wings carried by the exoskeleton, extending outwards from the exoskeleton itself and angularly movable relative to the exoskeleton around respective axes H transverse to the axis H; an electronic control unit adapted to control the thruster, to generate the release signal and adapted to control the actuators that perform the rotation of the wings; the electronic control unit is configured to control said wings to allow the rotation of the wings during the free-fall phase of said drone which is released from an aircraft and thereby performs a certain trajectory of said drone from the aircraft to a launch zone; the electronic unit is configured to enable the discharge of said liquid from said bag and the activation of the thrusters following the discharge of the liquid to enable the flight of the support structure and of the exoskeleton containing the empty bag to a landing zone.

### CROSS-REFERENCE TO RELATED APPLICATIONS

This Patent application claims priority from Italian Patent Application No. 102022000013687 filed on Jun. 28, 2022 the entire disclosure of which is incorporated herein by reference.

### TECHNICAL FIELD

The present invention refers to a fire fighting drone configured to be released from an aircraft.

### BACKGROUND

To extinguish fires in areas that are difficult for land fire fighting vehicles to reach, fire fighting liquids (water or chemical liquid fire retardants) are usually airdropped by helicopters or airplanes. These liquids are sprayed freely or released directly from containers used for their transport.

The main problems linked to airdropping can be summed up as follows:
a) free spraying, in order to be effective, involves launching at low altitude (i.e., as close as possible to the flames) which can only be implemented with helicopters and small airplanes; and
b) direct release, which has fewer risks for the aircraft used and makes it possible to launch larger amounts of liquids, on the other hand poses serious problems of protecting the surrounding environment, especially if the launching precision is dependent on a trajectory of the liquid released and of the container itself (although automatically lacerated to release the liquid into the air) prevalently determined by fall by gravity alone.

Therefore, there is the need to produce an aircraft that is capable of carrying a container in proximity to the fire and of releasing it at low altitude.

The document KR102189737 describes a rotary-wing drone for launching objects.

### SUMMARY OF THE INVENTION

The aforesaid object is achieved by the present invention as it relates to a fire fighting drone configured to be released from an aircraft of the type described in claim 1.

### BRIEF DESCRIPTION OF THE DRAWINGS

FIG. 1 illustrates, in a front view, a fire fighting drone configured to be released from an aircraft produced according to the dictates of the present invention;

FIG. 2 illustrates, in a bottom view, the drone of FIG. 1;

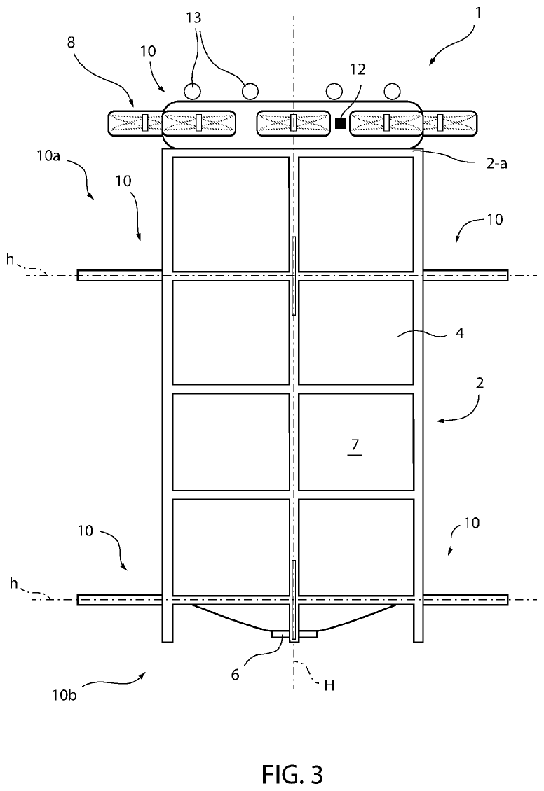

FIG. 3 illustrates the drone of FIG. 1 in a different operating position;

FIG. 4 illustrates an operation of discharging fire fighting liquid performed by the drone;

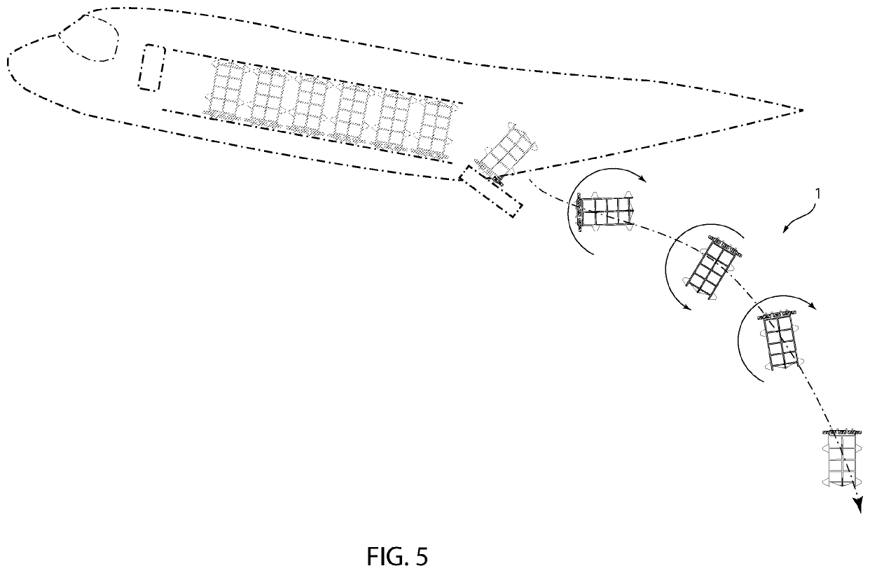

FIG. 5 illustrates an operation of launching the drone from the aircraft; and

FIGS. 6A and 6B illustrate operations performed by the drone configured to be released from an aircraft.

### DETAILED DESCRIPTION OF THE INVENTION

In the figures, the reference numeral 1 indicates, as a whole, a fire fighting drone configured to be released from an aircraft.

### The Fire Fighting Drone 1 Comprises:

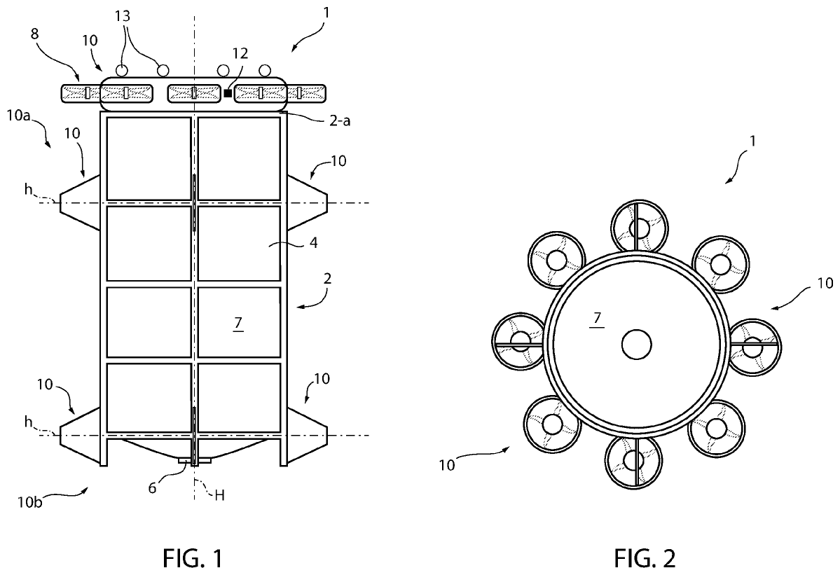

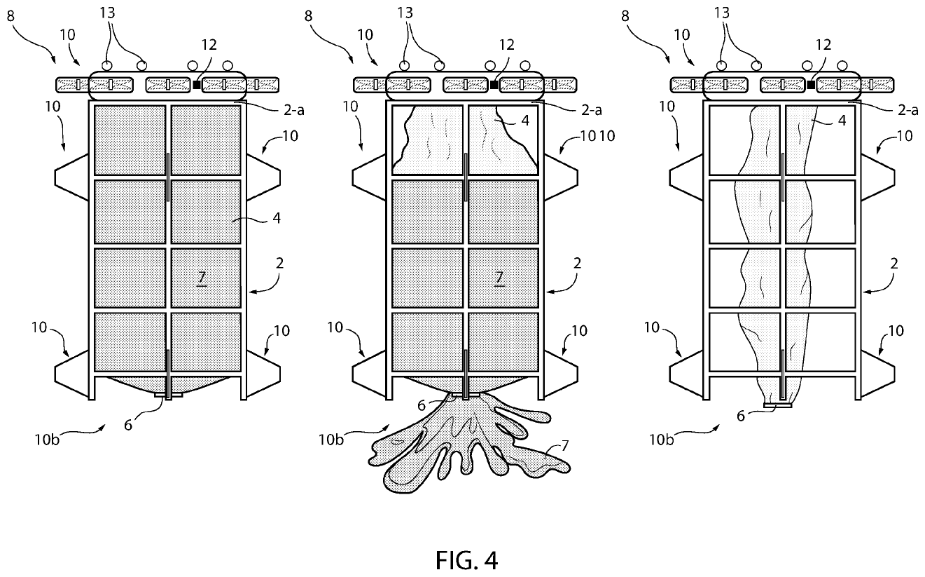

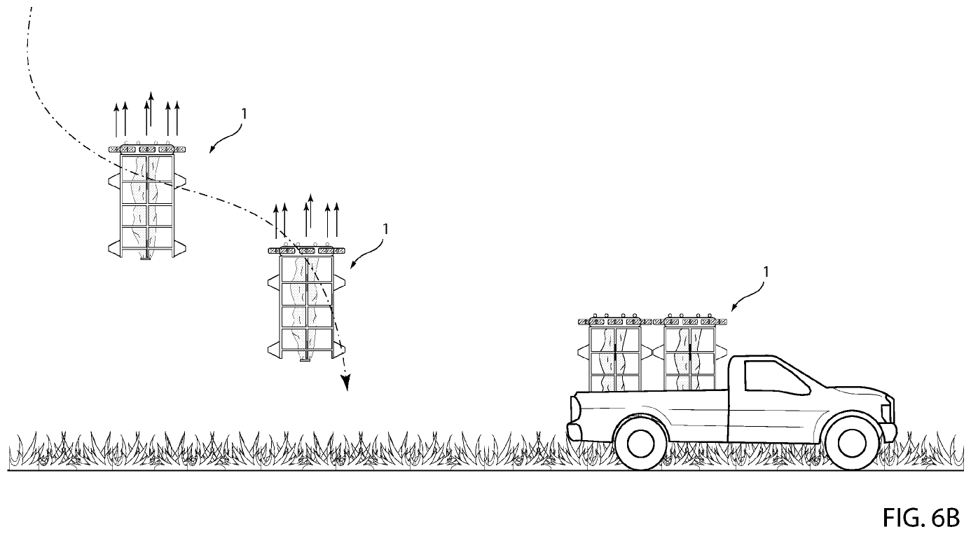

an exoskeleton 2 defining an internal cylindrical space 3 extending along an axis H (FIG. 1) and a flexible fabric bag 4 stably housed in the internal space 3, provided with a release valve 6 and configured to contain a fire fighting liquid 7—the release valve 6 may be set between a closed position and an open position following a release command;
an annular support structure 8 provided along its outer perimeter with a plurality of thrusters 10 (in the example ducted propellers with rotation axes parallel to the axis H operated by electric motors) adapted to produce a thrust that enables the support structure 8 to be supported in flight by means of technologies know per se—the support structure 8 is connected to a first end portion 2-a of the exoskeleton 2;
a plurality of movable directional wings 10 carried by the exoskeleton 2, extending outwards from the exoskeleton itself and angularly movable relative to the exoskeleton 2 around respective axes h perpendicular to the axis H (see FIGS. 1 and 3 in which the wings have different angular positions); pairs of wings 10a, 10b are spaced with respect to each other along directions parallel to the axis H; and an electronic control unit 12 adapted to control the motors of the thrusters 11, generate the release signal and adapted to control the actuators that perform the rotation of the wings 10
the electronic unit 12 is configured to control the wings 10 to produce a predetermined tilt of the wings during a free-fall phase of the drone 1 which is released from an aircraft and thereby performs a certain trajectory of the drone from the aircraft to a launch zone (see FIG. 6A). The aerodynamic forces that are generated are used on the directional wings 10 to change the trajectory of the drone, which otherwise would be determined by fall by gravity alone.

In the example represented the directional wings are of flat type and have a trapezoidal shape. The wings 10 are carried in pairs by uprights of the exoskeleton 2. The exoskeleton 2 can in fact be configured as a basket provided with rectilinear uprights parallel to the axis H and circular elements coaxial to the axis H and spaced from each other along the axis H itself.

Advantageously, the bag 2 is made of nylon or another impermeable fabric and has a cylindrical tubular shape when full.

The electronic unit 12 integrates the control software and the other software useful to the GNS (e.g. IMU, radar altimeter and GPS). The batteries (e.g. lithium-ion) that supply the unit 12 itself and the electric motors of the thruster 11 are also allocated in this unit 12.

The electronic unit 12 is configured to generate the release signal upon reaching a predetermined altitude HO optimal relative to the ground of a pre-set type (for example 30-60 metres or even higher, depending on the height of the flames—see FIG. 6A above) and based on the signal coming from sensors 13 adapted to detect a fire, for example, optical sensors or thermal sensors arranged on the annular structure 8. Preferably, the electronic unit 12 is configured to generate the release signal at an altitude greater than the optimal predetermined altitude if the thermal sensors detect a temperature greater than a pre-set threshold (for example 70 degrees or greater, depending on the protective heat shield used for the electronic unit) in order to prevent damage to the electronic unit 12.

A second end portion 2-b of the exoskeleton is provided with rollers or with wheels (not illustrated) for movement of the drone on the ground and its transport in the hold of the aircraft from which it will then be airdropped onto the target zone.

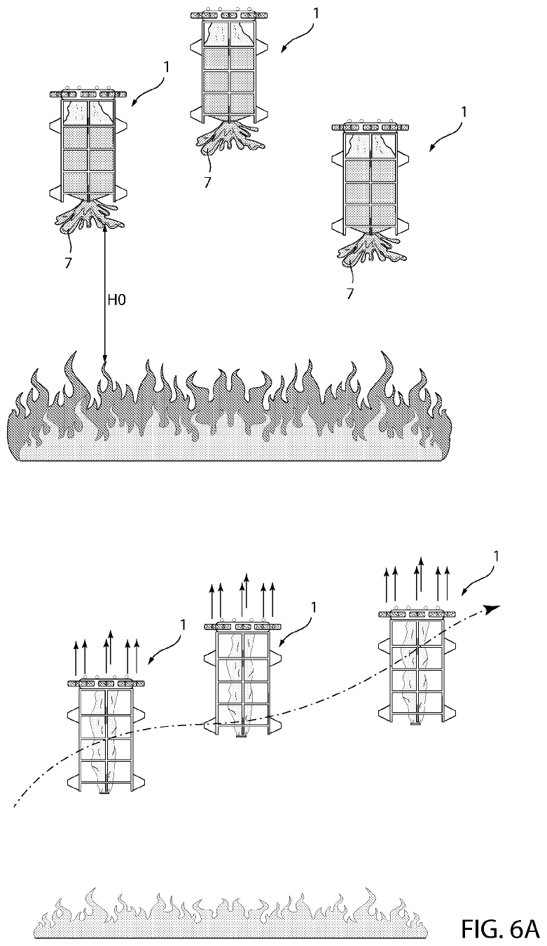

In use, the drone provided with a bag 4 filled with fire fighting liquid is loaded into the hold of a transport aircraft (FIG. 5—represented schematically), for example a transport aircraft internal with provided with an hold provided a rear loading/unloading hatch. The hatch is opened when the aircraft is in proximity of the fire and the drone 1 is released in known ways (sliding by gravity through the rear ramp of the aircraft). The drone then falls freely (see FIG. 5) as the electric motors of the thruster 11 are switched off. The free-fall trajectory is regulated by the electronic unit 12, which regulates the angle of the plane of the wings 10 relative to the direction of fall based on the signals generated by the sensors 13 generating aerodynamic forces that help to move the drone. In this way, the drone 1 moves as close as possible to the fire (FIG. 6A, above). The electronic unit regulates the rotations of the wings 10 as a function of the current position and of the target tracked, as far as possible with the GPS/IMU and then with the to the intrinsic reliability, the simplicity of its components and the possibility of reuse.

### NUMERALS

1 fire fighting drone.
2 exoskeleton.
3 internal space
H axis
4 bag
6 release valve
7 fire fighting liquid
8 annuler Support structure
10 wings
11 thrusters
12 electronic control unit
13 sensors

1. A fire fighting drone configured to be released from an aircraft comprising:
an exoskeleton (2) defining an internal space (3) extending along an axis H and a flexible bag (4) stably housed in the internal space (3), provided with a release valve (6) and configured to contain a fire fighting liquid (7); the release valve (6) configured to be set between a closed position and an open position following a release command;
a support structure (8) provided with a plurality of thrusters (11) adapted to perform a thrust that enables the support structure (8) to be supported in flight; the support structure (8) is connected to a first end portion (2-a) of the exoskeleton (2);
Characterised by Comprising:
a plurality of movable directional wings (10) carried by the exoskeleton (2), extending outwards from the exoskeleton itself and angularly movable relative to the exoskeleton (2) around respective axes H transverse to the axis H; pairs of directional wings (10a, 10b) are spaced with respect to each other along directions parallel to the axis H;
an electronic control unit (12) adapted to control said thrusters (11), generate said release signal and adapted to control the actuators that perform the rotation of said directional wings (10); said electronic unit (12) being configured to control said directional wings (10) to allow the rotation of the wings during a free-fall phase of said drone which is released from an aircraft and thereby performs a certain trajectory of said drone from the aircraft to a launch zone;
said electronic unit being configured to generate said release signal upon reaching the launch zone and enable the discharge of said liquid from said bag;
said electronic unit being adapted to perform the activation of said thrusters (11) following said discharge of said liquid to enable the flight of the support structure and of said exoskeleton containing the empty bag to a landing zone.

2. The drone according to claim 1, wherein said electronic unit (12) is configured to generate the release signal upon reaching a predetermined altitude (HO) optimal relative to the ground of a pre-set type and based on signals coming from sensors (13) adapted to detect a fire, for example, optical sensors or thermal sensors.

3. The drone according to claim 2, wherein said electronic unit is configured to generate the release signal at an altitude greater than the optimal predetermined altitude if said thermal sensors detect a temperature greater than a pre-set threshold in order to prevent damage to the electronic unit.

4. The drone according to claim 1, wherein the support structure (8) is of the annular type and is provided along its outer perimeter with a plurality of electric motors provided with propellers or turbines (10) with rotation axes parallel to the axis H.
